(19) United States
(12) Patent Application Publication
(10) Pub. No.: US 2003/0184165 A1
(43) Pub. Date: Oct. 2, 2003

(54) Miniature power generator serving as an emergency power source

(75) Inventor: Chun-Ming Chiu, Nan To Hsien (TW)

Correspondence Address: John S. Egbert, Harrison & Egbert, 7th Floor, 412 Main Street, Houston, TX, 77002, US

(73) Assignee: Hung-Tai Chang, Taichung Hsien (TW)

(21) Appl. No.: 10/270,204

(22) Filed: Oct. 15, 2002

(30) Foreign Application Priority Data
Mar. 27, 2002 (TW) 91202225

(51) Int. Cl. H02K 7/14; H02K 37/00

(52) U.S. Cl. 310/47; 310/75 R

(57) ABSTRACT

A hand-operated miniature power generator comprises a housing in which a driving member, a power generating member and an electronic circuit board are disposed. The driving member is manually operated to drive the power generating member to generate electric current, which may be taken for in-house consumption or external consumption by inserting a plug into an outlet of the electronic circuit board.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates generally to an emergency power generator, and more particularly to a miniature power generator serving as the source of power for some particular operation.

### BACKGROUND OF THE INVENTION

The conventional lighting structure, such as flashlight, is generally operated by batteries and is a useful adjunct serving as an indoor or outdoor power source. However, such conventional lighting structure is useless in case of exhaustion of the batteries. Similarly, a variety of electronic devices are operated by batteries. In the event that the batteries are exhausted of electrical charge, the electronic devices are instantly put out of operation unless the replacing batteries are at hand.

### BRIEF SUMMARY OF THE INVENTION

It is the primary objective of the present invention to provide a miniature power generator serving as an emergency lighting device.

It is another objective of the present invention to provide a miniature power generator serving as power source of various electronic devices.

In keeping with the principle of the present invention, the foregoing objectives of the present invention are attained by the miniature power generator comprising a housing, a driving member, a power generating member, and an electronic circuit board. As the driving member is manually driven so as to cause the power generating member to generate electric current, one or more light-emitting elements of the electronic circuit board are illuminated. The circuit board is provided with an outlet at which the electric current may be taken for consumption by inserting a plug.

The miniature power generator of the present invention further comprises a storage battery which is disposed in the interior of the housing such that the storage battery is connected to the electronic circuit board. The storage battery is used to store electrical charge and can be recharged by the power generating member. The storage battery can be also recharged by means of an external transformer.

The features, functions, and advantages of the present invention will be more readily understood upon a thoughtful deliberation of the following detailed description of the present invention with reference to the accompanying drawings.

### BRIEF DESCRIPTION OF THE SEVERAL VIEWS OF THE DRAWINGS

FIG. 1 shows a partial exploded view of the present invention.

FIG. 2 shows a complete exploded view of the present invention.

FIG. 3 shows a diagram of the circuit of the present invention.

FIG. 4 shows a schematic perspective view of the present invention in action.

FIG. 5 shows a schematic view of the present invention serving as power source of a mobile phone.

FIG. 6 shows a schematic view of the present invention serving as power source of a personal data assistant (PDA).

FIG. 7 shows a schematic view of the present invention serving as power source of a CD player.

FIG. 8 shows a schematic view of the present invention being recharged by a transformer.

### DETAILED DESCRIPTION OF THE INVENTION

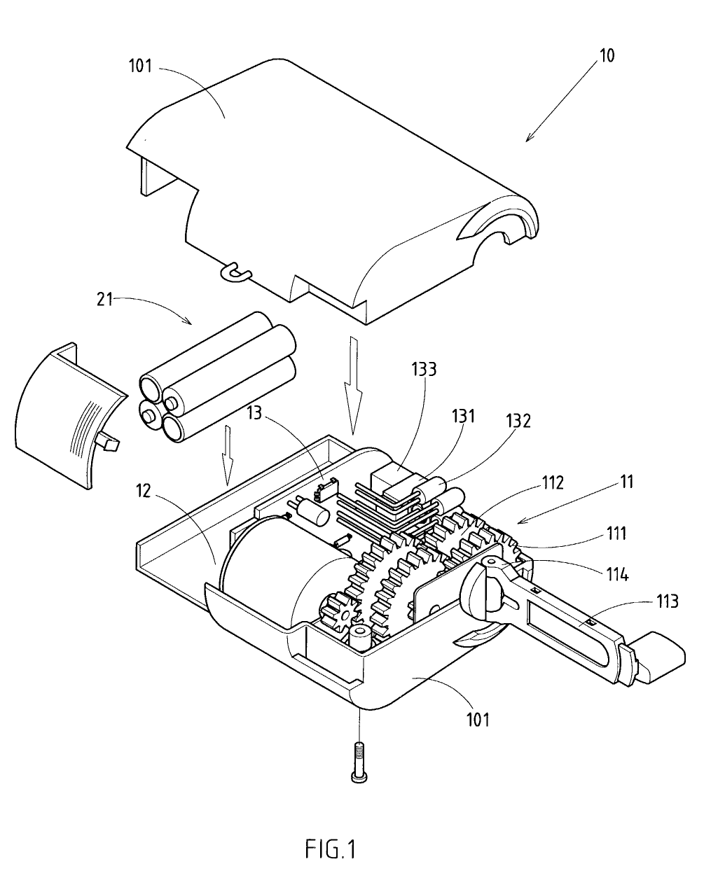

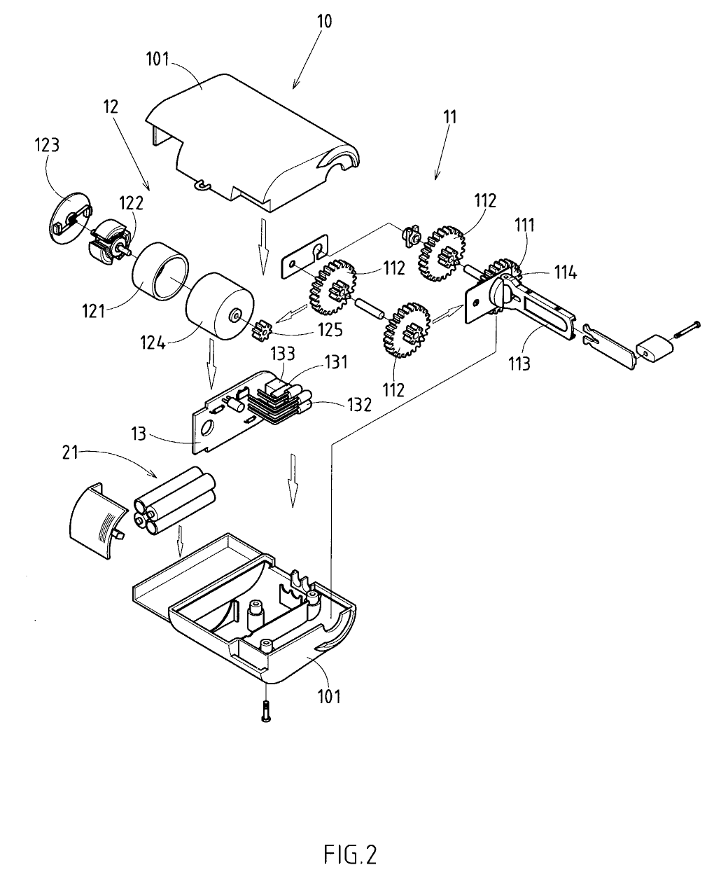

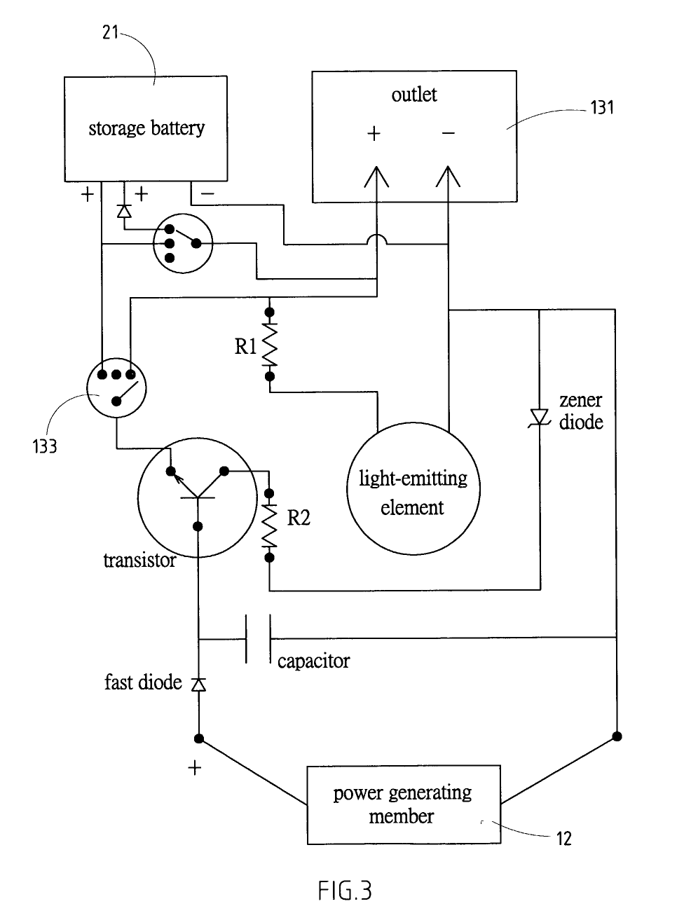

As shown in FIGS. 1-3, a miniature power generator embodied in the present invention comprises a housing 10, a driving member 11, a power generating member 12, and an electronic circuit board 13.

The housing 10 is provided with a receiving space which is formed and defined by two shielding pieces 101.

The driving member 11 is disposed in the receiving space of the interior of the housing 10 and is formed of a drive gear 111 and a plurality of differential transmission gears 12. The drive gear 111 is coaxially fastened with an actuating rod 113, which is provided at the fastening end thereof with a pivoting portion 114 enabling the actuating rod 113 to swivel toward or away from the housing 10. The actuating rod 113 is always located in the outside of the housing 10.

The power generating member 12 is formed of a casing 124 in which a magnetic element 121, a core 122, and a brush plate 123 are disposed. The core 122 is provided with a plurality of induction coils, which are located in the magnetic element 121, with one end of the core 122 extending out of the casing 124 to fasten with a driven gear 125 which is engaged with one of the differential transmission gears 112 of the driving member 11. The core 122 is fastened at other end thereof with the brush plate 123.

The electronic circuit board 13 is connected with the brush plate 123 of the power generating member 12 and is provided with an outlet 131, an ON-OFF switch 133, and one or more light-emitting elements 132, such as light-emitting diodes.

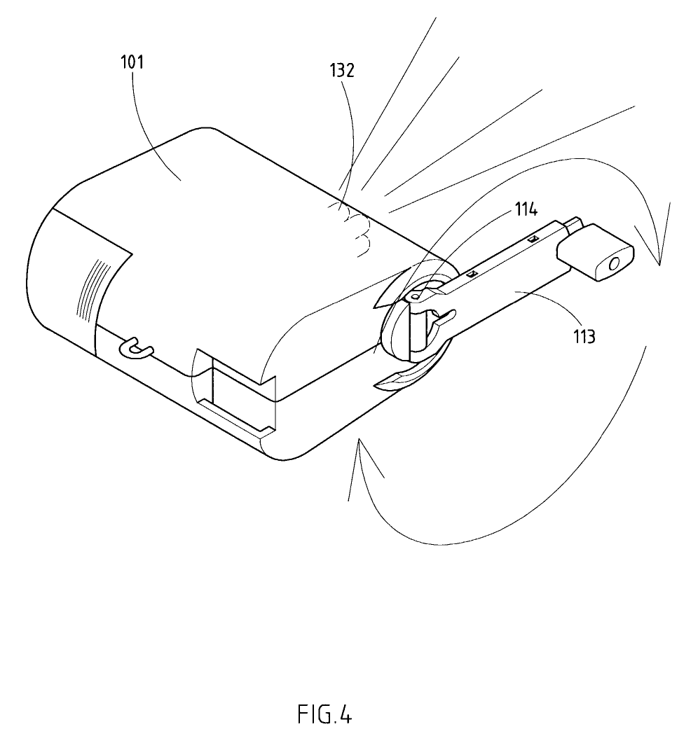

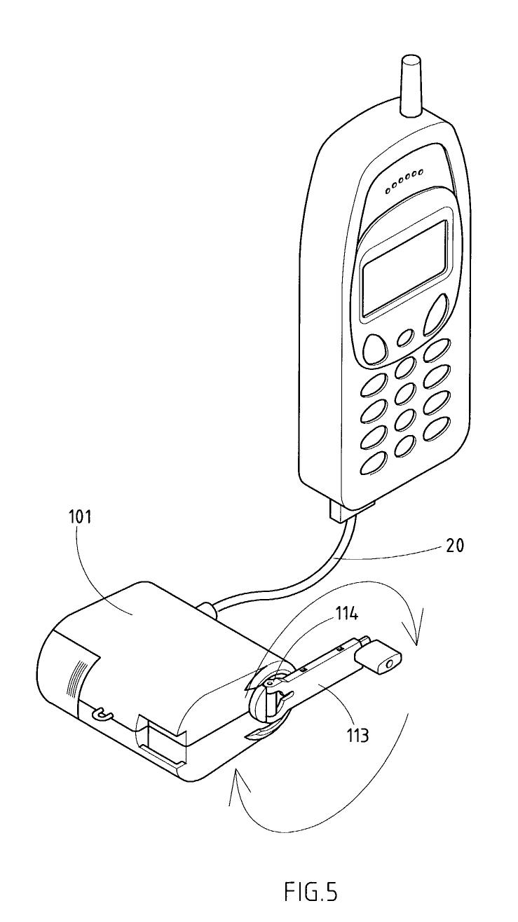

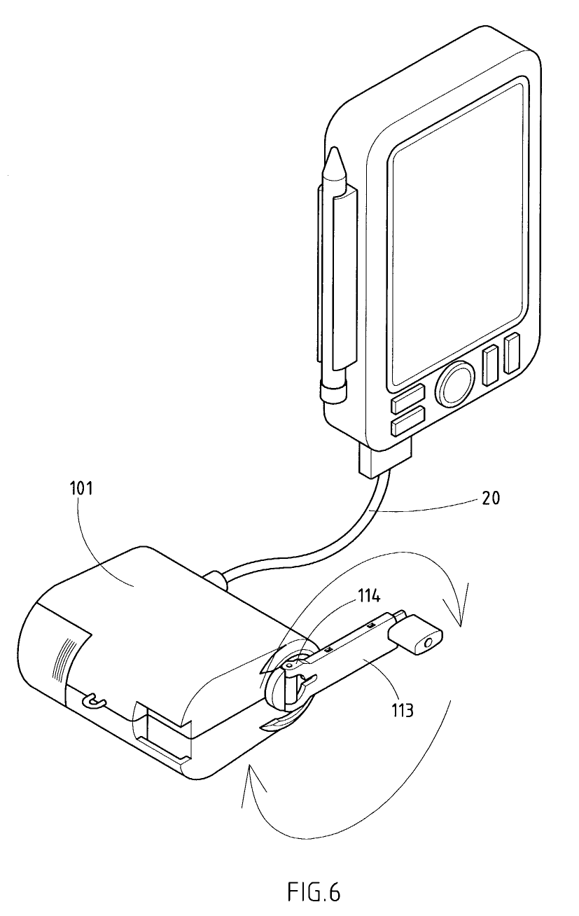

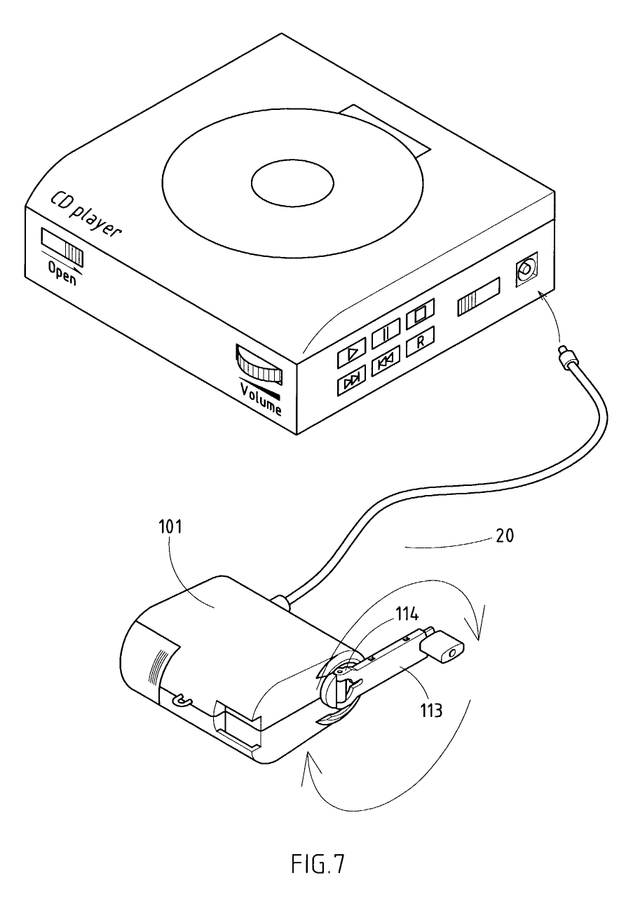

In operation, the drive gear 111 of the driving member 11 is actuated to turn by the actuating rod 113 which is manually turned. As a result, the motion is imparted to the driven gear 125 via the differential transmission gears 112. The core 122 is driven by the driven gear 125 in motion. The electric current is brought about by induction when the induction coils of the core 122 are exposed to the influence of the magnetic field formed by the magnetic element 121. The electric current is made available to the electronic circuit board 13 by means of the brush plate 123 and a wire (not shown in the drawings). The electric current is used to illuminate the light-emitting elements 132, as illustrated in FIG. 4. In addition, the present invention may be used as an emergency power source for operation of a mobile phone as shown in FIG. 5, a personal data assistant (PDA) as shown in FIG. 6, a CD player as shown in FIG. 7, and the like. The electric current generated by the present invention is made available to the electronic devices referred to above via the output outlet 131 into which the plug of a cord 20 is inserted.

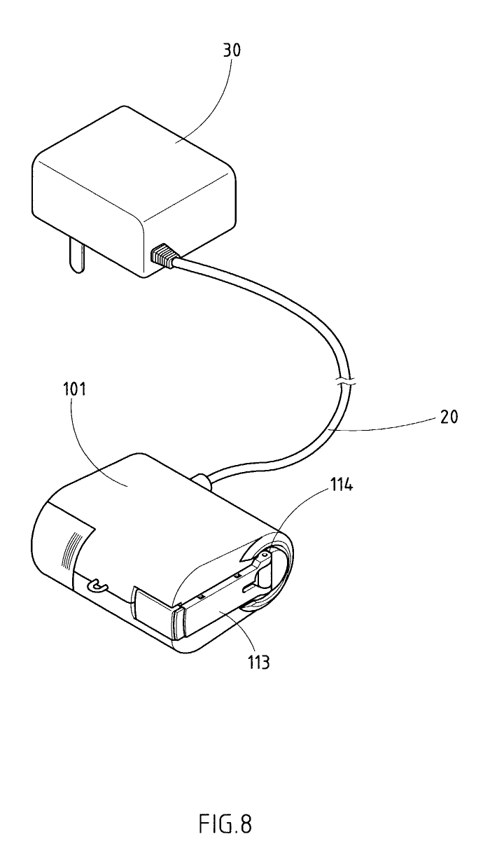

The present invention further comprises a storage battery 21 which is disposed in the receiving space of the interior of the housing 10 such that the storage battery 21 is connected to the electronic circuit board 13. The electric charge generated by the power generating member 12 can be stored by the storage battery 21 for later use. The storage battery 21 can be recharged by the in-house power generating member 12, or by an external transformer 30, as illustrated in FIG. 8.

The present invention described above is to be regarded in all respects as being illustrative and nonrestrictive. Accordingly, the present invention may be embodied in other specific forms without deviating from the spirit thereof/ The present invention is therefore to be limited only by the scopes of the following claims.

I claim:

1. A miniature power generator comprising:
a housing provided in an interior with a receiving space;
a driving member disposed in said receiving space of said housing and formed of a drive gear, a plurality of differential transmission gears, and an actuating rod fastened coaxially at a fastening end thereof with said drive gear such that said actuating rod is located in the outside of said housing;
a power generating member disposed in said receiving space of said housing and formed of a casing, a magnetic element disposed in said casing, a core provided with a plurality of induction coils and disposed in said magnetic element such that one end of said core is extended out of said casing, a driven gear fastened with said one end of said core and engaged with one of said differential transmission gears of said driving member, and a brush plate fastened with other end of said core; and
an electronic circuit board disposed in said receiving space of said housing and connected with said brush plate of said power generating member whereby said electronic circuit board is provided with an outlet, an ON-OFF switch, and one or more light-emitting elements.

2. The miniature power generator as defined in claim 1, wherein said actuating rod of said driving member is provided at the fastening end thereof with a pivoting portion enabling said actuating rod to swivel toward or away from said housing.

3. The miniature power generator as defined in claim 1, wherein said light-emitting elements of said electronic circuit board are light-emitting diodes.

4. The miniature power generator as defined in claim 1 further comprising a storage battery which is disposed in said receiving space of said housing and is connected to said electronic circuit board.

5. The miniature power generator as defined in claim 4, wherein said storage battery can be recharged by an external transformer.
